(19) United States
(12) Patent Application Publication
(10) Pub. No.: US 2003/0235112 A1
(43) Pub. Date: Dec. 25, 2003

(54) Interferometric imaging method apparatus and system

(76) Inventors: Matthew J. Zimmerman, Providence, RI (US); James H. Miller, Kingston, RI (US)

Correspondence Address: LYON & LYON LLP, 633 WEST FIFTH STREET, SUITE 4700, LOS ANGELES, CA, 90071, US

(21) Appl. No.: 10/177,889

(22) Filed: Jun. 21, 2002

(51) Int. Cl. H04B 1/59

(52) U.S. Cl. 367/4

(57) ABSTRACT

An imaging sonar system develops three-dimensional images of the space below, to the sides, and forward of a ship. Various features permit the system to be used in non-military environments and make possible low cost with substantial capabilities.

### PRIORITY

Priority is claimed to U.S. patent application Serial No. 60/299,864, which was filed on Jun. 21, 2001.

### BACKGROUND OF THE INVENTION

### BACKGROUND

There are many types of sonar systems used for military, commercial, and recreational purposes. Generally, the more sophisticated systems that produce three-dimensional images are found in military vessels, but not in commercial or recreational vessels. However, one type of system that is capable of producing three-dimensional images is in use in larger commercial and recreational vessels generates a planar beam ping and receives echoes using a planar receiving “beam” that is perpendicular to it. This allows the system to select a particular spherical angle “pixel” which, when combined with the return reflection travel time, allows the construction of three dimensional information. The system is downward-looking and used for bottom mapping. The latter system is expensive because the transmit power has to be regulated to beam-form the outgoing signal. At present commercial forward-looking navigation sonars in 3D having any array geometry are unknown. There are only short range 3D imaging sonars which take only two-dimensional pictures, which are not useful for navigation. except for planar arrays, which use a matrix of many sensors to form images, which require many channels and are thus very expensive as well.

In the field of interferometry, arrays of many receivers are used, which enable a user or an autonomous system controller to make precise angular measurements for long-range detection, imaging, object classification, obstacle avoidance, etc. The operating frequencies can vary between a few Hz for seismic applications to many Megahertz or Gigahertz for ultrasound and radio systems. The sensors are usually arranged in an array in order to improve the signal to noise ratio for better detection. In such an array, the receiver hardware must be replicated for each channel. Since the number of array elements can vary from a minimum of four to several thousand, the cost for the receiver hardware can be a real burden. Furthermore, in order to perform the additional operations required for detection, for example: beam forming and multi-beam processing; each sensor output must be connected to a central signal processor. Depending on the number of array elements, this can create a serious wiring burden. Finally, since the sensors detect analog signals while the central processing unit operates in the digital domain, each channel must be equipped with a high-resolution analog-to-digital converter (ADC). The complexity of these systems limit the ability to provide for upgrades and modifications and render repairs expensive.

### SUMMARY OF THE INVENTION

A forward looking (side looking, or bottom looking) sonar system has the following features. A Mills cross interferometric method is used to image a volume of water ahead of, or to the side of, a boat. The technique provides high resolution, which is traded for the high signal to noise ratio of full arrays with a same number of channels. In an exemplary embodiment, 8 channels on each leg of an L-shaped array of hydrophone receivers provide the resolution of a full array of 64 receiving hydrophones, although signal strength is sacrificed. However, the resolution gained permits high resolution three-dimensional imaging for systems that are much less expensive than full the array counterparts used primarily in the military.

A preferred method of mounting the modules is to insert them into a block of potting material as described in U.S. Patent Application No. 60/299,864, which was filed on Jun. 21, 2001, which is hereby incorporated by reference as fully set forth in is entirety herein. A filler material may be provided to insure that there are no air gaps between the potted modules and the “chassis.” Oil, tar, or elastomer may be used for this purpose. In small vessels, the array may be projected on a short tower through an opening in the hull. In larger vessels, particularly high performance vessels such as racing sailboats, the chassis may be formed in the shape of the hull of the boat with all the sensors aimed in the selected direction. Preferably, at least one temperature sensor is located to determine the temperature of the water at the interface between the water and the array to deduce the index of refraction of the water and compensate in coordinate calculation for refraction according to known mathematical techniques.

Also, the invention may increase market penetration to the point that there are many vessels with imaging sonar and interference between sonar signals may become a problem. A proposed solution is to permit variation of the center frequency over a limited range to permit the system to find frequency channel with low power levels from other sonar systems. According to a preferred embodiment, the frequency hunting may be done automatically by sensing the sound pressure at various frequencies, around the one for which the system is designed, for a center at which there is low power.

In a preferred embodiment, each of the receivers is potted alone or in combination with multiple receivers along with electronics and an interface such that the only interface requirements with the module are the input of power and a clocking signal and the output of a down-converted digital signal ready to be numerically processed into image data.

In a feature of the invention, the sensors are mounted to face in a direction of view but are not mounted in a plane perpendicular to the direction of view. The displacements of each from a common plane may be compensated for numerically in the process of coordinate calculation. In another alternative, the sensors are not mounted in a plane at all but follow some contour of the vessel hull. For example, the chassis supporting the Mills Cross array can be mounted in the inverted T-shaped forward surface of the winged keel of a sailboat. Numerical compensation for any of these alternatives is straightforward, mathematically and the details do not need to be discussed herein. For very large vessels and using long range systems (and correspondingly low frequency signals), the chassis or monolithic array may be mounted inside the hull without significant distortion effects otherwise a compatible hull material may be employed in the vicinity of the sonar chassis. This is because the effect of the hull, which could be an inch or so thick, would not greatly interfere with the return signals.

To maximize the sensitivity of the system and minimize the physical size of the array, sensors may be made as large as permissible by the physical configuration. For example, the dimension of the sensors along the axis of adjacent sensors may be as great as their spacing so that there are no gaps between adjacent sensors. Where the sensors are formed into modules of multiple sensors, the end sensors may be made slightly smaller, with numerical compensation for the lower sensitivity provided automatically.

The physical mounting of the array presents challenges. Preferably, the array and its support are configured to permit them to be passed through standard port structures built into the hull of the vessel.

The use of a Mills cross requires high speed digital processing to acquire three-dimensional images, but the resolution is maximized for the number of receivers. According to an embodiment of the invention, the three-dimensional data in the form of three voxel coordinates plus return echo intensity is generated in a server processor and distributed to one or more user interface clients through a network, for example, an Ethernet packet network. With the use of a network, client terminals may be located off the platform (ship) carrying the sonar permitting a remote navigator to serve multiple ships. To provide accurate three-dimensional data, roll and tilt sensors are preferably mounted on the vessel. The orientation of the vessel may then be determined to provide two coordinates in a spherical coordinate system. The third dimension, the radius, may be provided by the travel time of the outgoing sonar signal. The array geometry and the signal processing give target placement relative to the array/ship so the roll and tilt sensors may be used for a 2 axis coordinate rotation to reference the data to earth.

In an embodiment of the invention, the three-dimensional data is provided rapidly by generating a single ping and beam forming the receiving signal over all solid angles permitted by the Mills Cross receiver array. In this way, a full image can be generated for each outgoing ping. The outgoing pings are preferably generated by a single transducer which may consist of one or more elements to generate a wide lobe. That is, the ping ensonifies a wide area and the interferometric processing provides the high resolution image using known techniques of interferometry, for example as applied in the well-known Very Large Array (VLA) radio telescope.

The three-dimensional data may be displayed in various formats. Two-dimensional projections of the voxels, with suitable highlighting to represent return echo intensity, may be projected on a display. Another format can be generated by first identifying targets and representing the targets symbolically on a display. For example, the targets may be classified according to pattern recognition processes that are well known in the video object recognition art, for example, in industrial processes. Each recognized target may then be represented by a symbol corresponding to the target. Examples of techniques for highlighting to indicate intensity (or any choice of third dimension, for example depth) include color, pixel size (mosaic filter), color saturation, pixel intensity, symbol size, and text indicia. Other ways of representing the three-dimensional data on a two dimensional screen is to permit active rotation of the projection camera angle as is done in three-dimensional modeling (e.g., animation) software and CAD programs. Still another is to provide a fixed set of two or more possibly orthogonal projections or views with controls to allow the user to switch among them.

Since the sonar system is capable of creating a three-dimensional view of a volume of water including its bottom, and even below the bottom surface, the user interface part of the system may be configured to generate map data that may be overlaid on existing maps or used to override or modify existing map data to make it more current. The update data may be shared among a network of vessels to provide current detail on changing conditions such as the presence of sea animals, changes in sediment levels, presence of wrecks, etc. Given the network capability of the sonar system described, such data sharing can be done with ease.

Hydrophones used for emitting and receiving sonar signals may be configured in modular components. Such components may be packaged such that all A/D conversion is done within the modules and only digital signals are required to be extended beyond the modules. According to a refinement, the signals may be multiplexed reducing the physical channel count for interconnection. Still another refinement may be the combination of multiple sensors in a single module that may be combined with multiple other modules to form arrays of arbitrary size.

The invention will be described in connection with certain preferred embodiments, with reference to the following illustrative figures so that it may be more fully understood. With reference to the figures, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

### BRIEF DESCRIPTION OF THE DRAWINGS

FIG. 1 is a figurative illustration of a ship with a sonar array mounted on a stalk extending from the hull of a ship.

FIGS. 2A and 2B are figurative illustrations, in side and plan views, respectively, of a ship with a array of sonar hydrophones oriented in a direction of travel of the ship but arranged to follow the contour of the ship's hull.

FIGS. 3A and 3B are figurative illustrations of a sailboat with a winged keel, from respective side and front views, the keel having a sonar array mounted on it.

FIG. 4 is a figurative illustration of a ship with an internally-mounted sonar array.

FIG. 5A is a figurative illustration of a module with four sonar hydrophones.

FIGS. 5B and 5B are figurative illustrations of, respectively, a sonar array module and an example of a structure that may be built from the module according to an embodiment of the invention.

FIG. 6 is a figurative illustration of an L-shaped sonar array formed of modules with multiple hydrophones in each module for highlighting dimensional features of the modules.

FIG. 7 is an illustration of a network for distributing sonar image information to local and remote locations via a network.

FIG. 8 illustrates one way of displaying sonar data using a projection of voxels in a user interface of a sonar system.

FIGS. 9A and 9B illustrates a portion of a display with pixel data derived from three-dimensional voxel data in a user interface of a sonar system.

FIGS. 10A and 10B illustrate replacing voxel projections with symbols corresponding to classes of objects and displaying the symbols in place of the projected voxel data in a user interface of a sonar system.

FIGS. 11A, 11B, and 11C, illustrate active rotation of a three dimensional data to allow dynamic inspection by a user of the projection in a user interface of a sonar system.

FIG. 12 is an illustration of a map display with sonar-derived data overlaid on it in a user interface of a sonar system.

FIG. 13 is a modular array for discussing certain mechanical issues with respect to the sonar array.

### DETAILED DESCRIPTION OF THE PREFERRED EMBODIMENTS

In a forward-looking (sidescan, or bottom scanning) sonar system an interferometric method is used to image a volume of water ahead of or to the side of a boat. By using a subset of a full array of hydrophones distributed across a larger area, high-resolution is traded for high signal to noise ratio that would be obtained with a full array distributed over a similar area. In an exemplary embodiment, 8 channels on each leg of an L-shaped array of hydrophone receivers provide the resolution of a full array of 64 receiving hydrophones, although signal strength is sacrificed. However, the resolution gained permits high resolution three-dimensional imaging for systems that are much less expensive than full the array counterparts used primarily in the military.

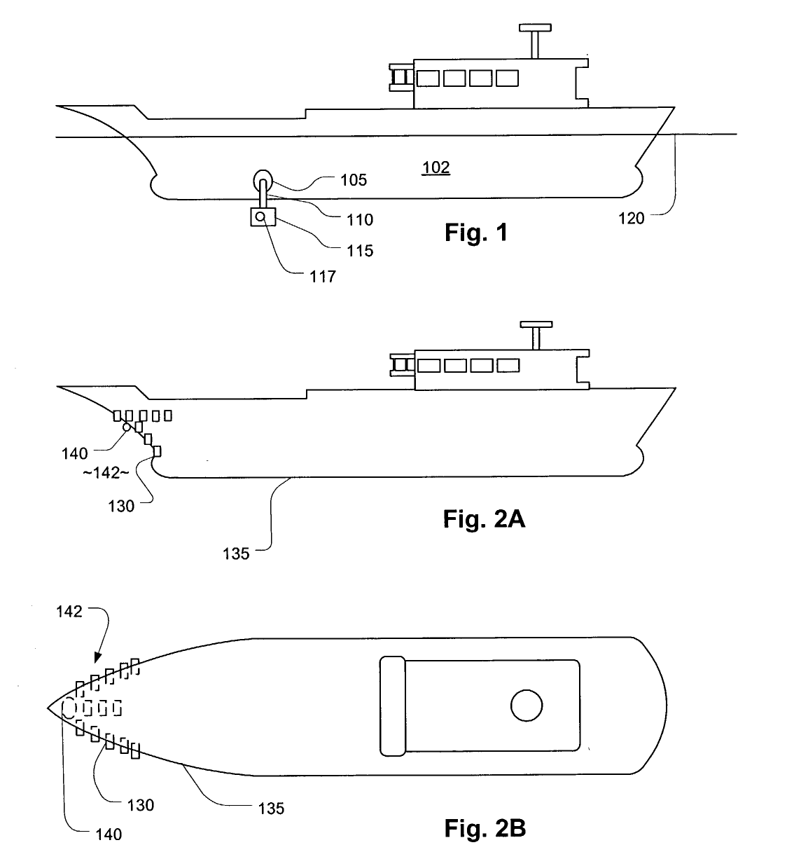

The physical mounting of the array presents challenges. In an embodiment the Mills Cross receivers may be potted in a single monolithic structure of material that has the same acoustical properties as water. The emitter may be embedded in the same potting. Referring to FIG. 1, an array 115 formed in a modular package may be projected on a short tower 110 through an opening 105 in the hull 102 of a ship such that the array is below the waterline 120. Preferably, the array and its support are configured to permit them to be passed through standard port structures built into the hull of the vessel. The configuration of FIG. 1 may be a preferred configuration for smaller vessels. Preferably, at least one temperature sensor 117 is located to determine the temperature of the water at the interface between the water and the array 115 to deduce the index of refraction of the water and compensate in coordinate calculation for refraction according to known mathematical techniques.

Referring to FIGS. 2A and 2B, in larger vessels, particularly high performance vessels such as racing sailboats and commercial ships, an array 142 may be formed in the shape of the hull of a ship 135 and all the receiving hydrophones, for example as indicated at 130, may be aimed in the selected direction. In all the embodiments, as illustrated here, a transmitter hydrophone 140 may be located near the receiving hydrophones 130 to generate a ping which permits a full image to be obtained with each ping by recording data from all receiving phones and reducing the data to obtain selective “view angles” by beam-forming, a technique whose details need not be explained in detail since they are well-documented.

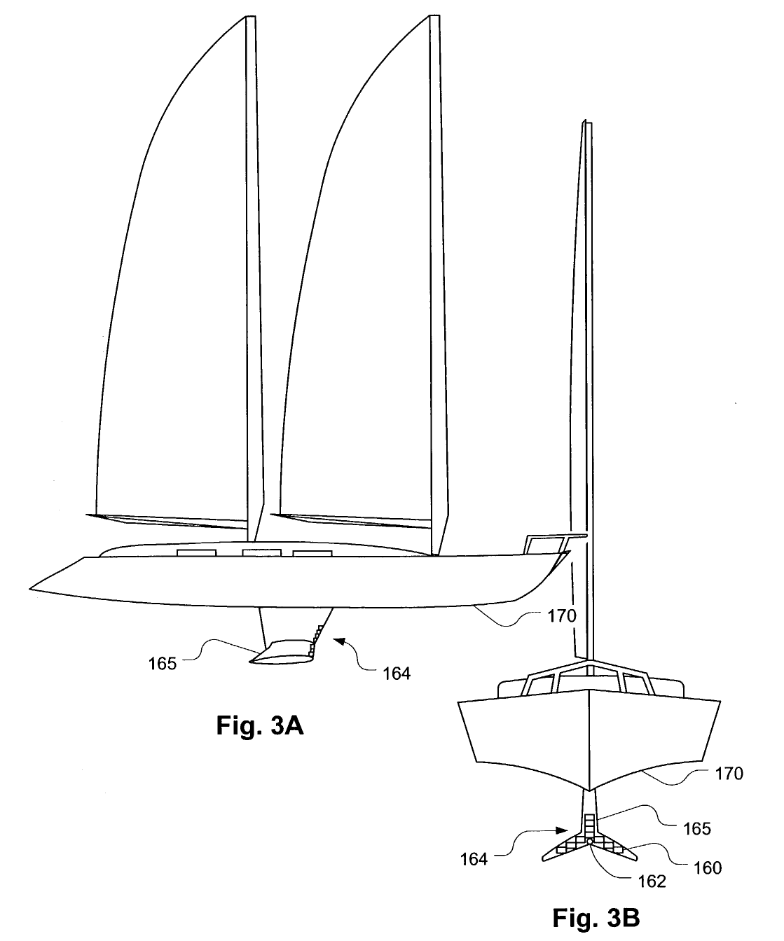

The hydrophones 130, though mounted to face in a direction of view, and thereby not mounted in a common plane perpendicular to the direction of view, can still image in the same way as a planar array. The displacements of the array sections from a common plane may be compensated for numerically in the process of coordinate calculation. In another alternative, the hydrophones 130 are not mounted in a plane at all but follow the contours of the vessel hull 135 as indicated at 142. For example, as shown in FIGS. 3A and 3B, an array 164 with receiving 160 and a transmitting 162 hydrophones in a Mills Cross array 164 may be mounted in the inverted T-shaped forward surface of the winged keel 165 of a sailboat 170. Numerical compensation for any of these alternatives is straightforward, mathematically, and the details do not need to be discussed herein.

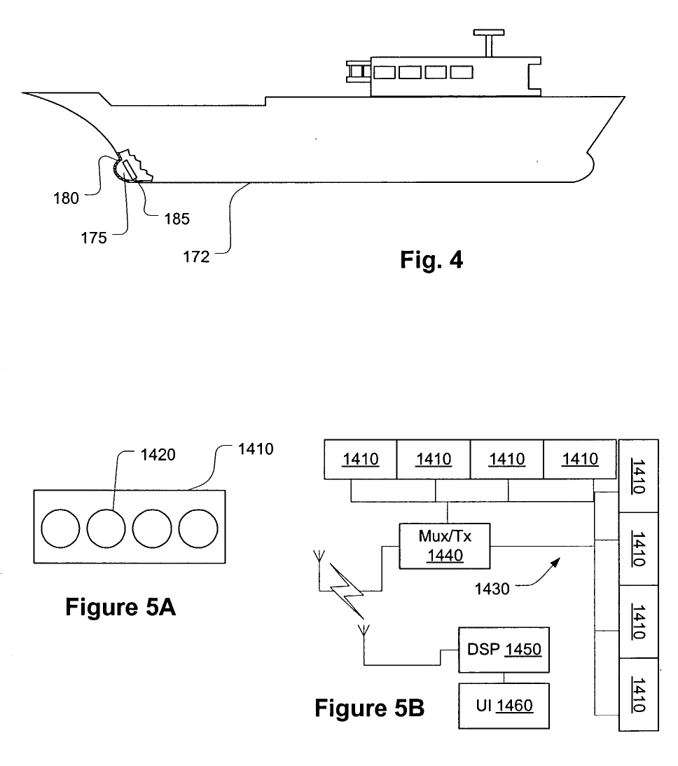

Referring now to FIG. 4, for very large vessels and using long range systems (and correspondingly low frequency signals), an array 185 may be mounted inside 175 the hull 172 without significant distortion effects. This is because the effect of the thickness 180 of the hull 172, which could be an inch or so, may not greatly interfere with the return signals when low frequencies are used.

Referring to FIGS. 5A and 5B, the receiving hydrophones (or more generically: “sensors”) 1410, may be used to create a system, for example a Mills Cross array 1430. Multiple modular assemblies 1410 each of which may include multiple individual sensors 1420, four being shown in FIG. 14A, but any number being possible depending various criteria such as the frequency of the signal, the range, various mechanical considerations and considerations of manufacturability and convenience as well as others. Each modular sensor assembly may be potted as a monolithic unit with a single digital channel output to a Mux/transmitter unit 1440. The latter may communicate with the digital signal processor 1450 using any desired method, for example by radio signals as illustrated. The digital signal processor 1450 outputs its signals to a user interface device 1460 through a suitable mechanism. In a preferred embodiment, the digital signal processor 1450 outputs through a network, such as Ethernet (IP, for example) to allow the connection of multiple user interface devices to the same data source 1440.

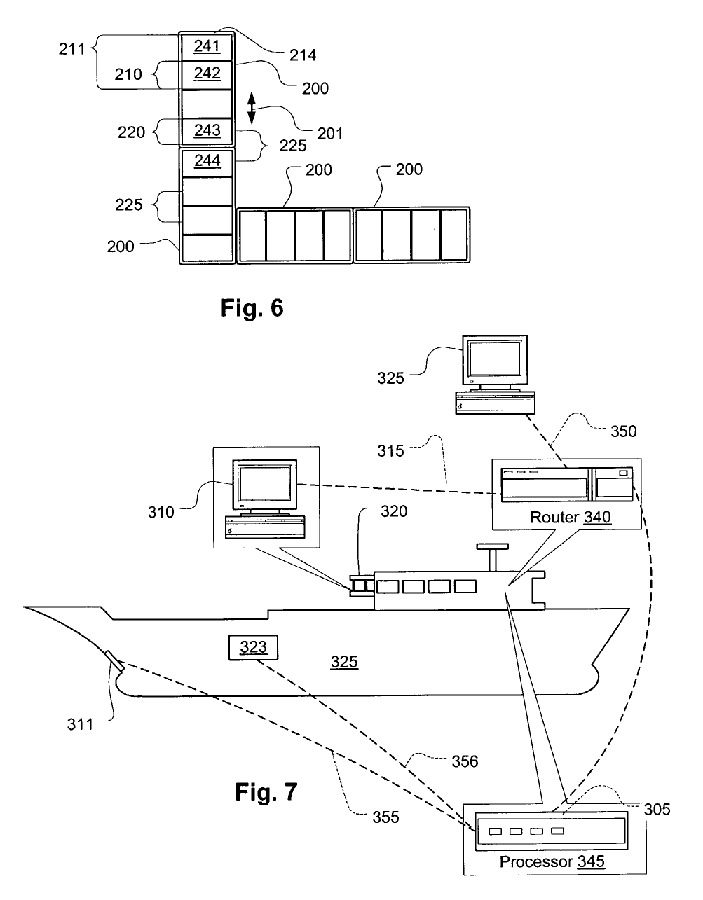

Referring now to FIG. 6, to maximize the sensitivity of the system and minimize the physical size of the array, hydrophone receivers may be made as large as permissible by the physical configuration. For example, the dimension 210 of the hydrophone receivers 242 along the axis 201 of adjacent hydrophone receivers e.g. 241 and 242 may be as great as their spacing 211 permits so that there are no gaps between adjacent sensors e.g., 241 and 242. Where the sensors are formed into modules 200 of multiple sensors, for example those indicated at 241-244 and similar, the end sensors e.g., 241 and 243 on each module 200 may be made slightly smaller to accommodate potting material or other enclosure thickness, with numerical compensation for the lower sensitivity provided automatically.

Referring to FIG. 7, the use of a sparse array such as the Mills cross requires high speed digital processing to acquire three-dimensional images, but the resolution enhanced relative to the same number of receivers for a non-sparse array. According to an embodiment of the invention, the three-dimensional data from an array 311, are sent to a server processor 305 via a data link 355 and reduced data distributed to one or more user interface clients 310, 325 through a network. For example, the network may be an Ethernet packet network which generally includes a router 340, and wired or wireless links 315, 350. The data may be distributed from the server in the form of three voxel coordinates plus return echo intensity. Alternatively, the data may be distributed with great or lesser degrees of reduction to permit alternative algorithms to be applied in the analysis and reduction. This data packaging would permit the clients 310, 325 to analyze data independently of each other but keep the data load low. With the use of a network, client terminals, e.g. 325 may be located off the platform 325 (ship) carrying the sonar permitting a remote navigator to serve multiple ships.

To provide accurate three-dimensional data, roll and tilt sensors 323 are preferably mounted on the vessel 325 to send data to the processor 345 via a data link 356. The orientation of the vessel 325 may then be determined to provide two coordinates in a spherical coordinate system. The third dimension, the radius, may be provided by the travel time of the outgoing sonar signal.

The three-dimensional data may be provided rapidly by generating a single ping and beam-forming the receiving signal over all solid angles permitted by the sensor array. In this way, a full image can be generated for each outgoing ping. The outgoing pings are preferably generated by a transducer (e.g., FIG. 1, 140), which may consist of one or more elements to generate a wide lobe. That is, the ping ensonifies a wide area and the interferometric processing provides the high resolution image using known techniques of interferometry.

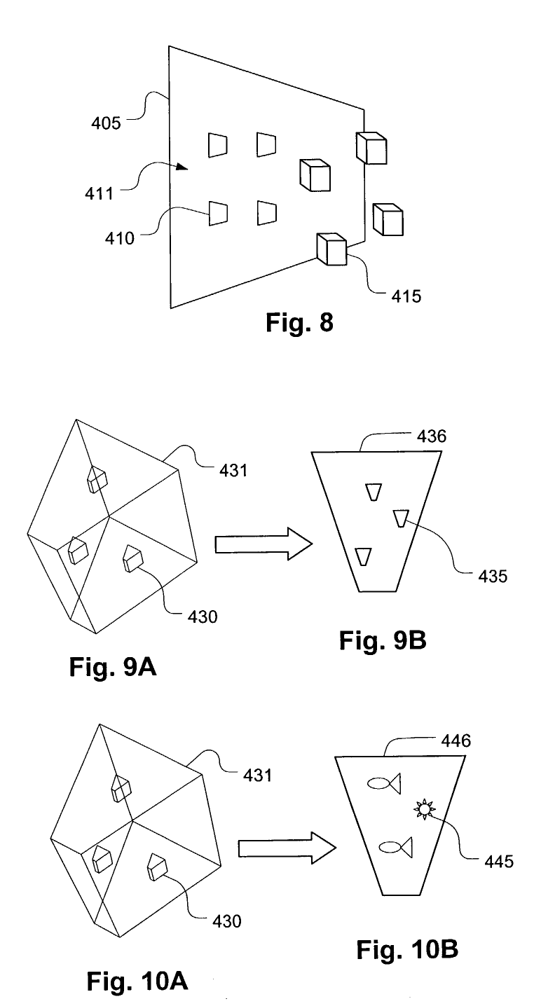

Referring now to FIG. 8, the three-dimensional data that results from the reduction of the raw sonar data may be displayed in various formats. For example, a two-dimensional projection 411 of voxels 415 may be rendered as a suitable display, such as on a computer display. In the figure, each voxel 415 is projected to an imaginary plane 405 to yield a projection 410 thereof. Examples of techniques for highlighting to indicate intensity of the return echo or any choice of third dimension, for example depth, include color, pixel size (mosaic filter), color saturation, pixel intensity, symbol size, and text indicia, etc.). The user interface may permit rotation of the projection in an arbitrary orientation as illustrated in FIGS. 9A and 9B showing an arbitrary volume 431 with features indicated by highlighted voxels 430 to be viewed from alternative angles e.g., volume 431 rotated to 436 and highlighted voxel projection showing at 430 and 435, respectively.

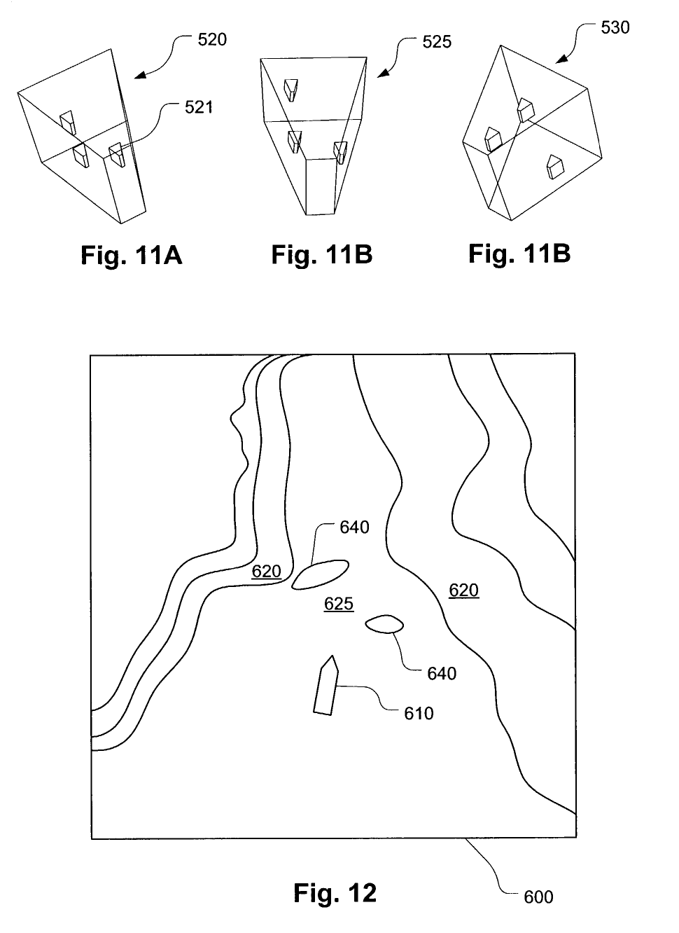

Referring to FIGS. 10A and 10B, another format can be generated by first identifying targets and representing the targets symbolically e.g. 445 on the display. For example, the targets may be classified according to pattern recognition processes that are well known in the video object recognition art, for example, in industrial processes. Each recognized target may then be represented by a symbol (e.g. 445) corresponding to the type of target.

Referring now to FIGS. 11A, 11B, and 11C, other ways to representing the three-dimensional data on a two dimensional screen include permitting active rotation of the projection camera angle as is done in three-dimensional modeling (e.g., animation) software and CAD programs. In FIGS. 11A, 11B, and 11C, an arbitrary volume with highlighted voxels (e.g., shown in projection at 521) is projected at three respective angles to yield three projection 520, 525, and 530 at each. Another alternative is to provide a fixed set of two or more possibly orthogonal projections or views with controls to allow the user to switch among them.

Since the sonar system is capable of creating a three-dimensional view of a volume of water including its bottom, and even below the bottom surface, the user interface part of the system may be configured to generate map data that may be overlaid on existing maps or used to override or modify existing map data to make it more current. Referring to FIG. 12, a map 600 with features 620 including a waterway 625 is projected on a display showing the position of a ship 610 and overlaid with features 640 revealed by the sonar system. As illustrated above, The live data may be shared among a network of vessels to provide current detail on changing conditions such as the presence of sea animals, changes in sediment levels, presence of wrecks, etc. Given the network capability of the sonar system described, such data sharing can be done in a straightforward manner.

The use of “sparse” arrays like the Mills cross may increase market penetration to the point that there are many vessels with imaging sonar and intereference between sonar signals may become a problem. A proposed solution is to permit variation of the center frequency over a limited range to permit the system to find frequency channel with low power levels from other sonar systems. According to a preferred embodiment, the frequency hunting may be done automatically by sensing the sound pressure at various frequencies, around the one for which the system is designed, for a center at which there is low power.

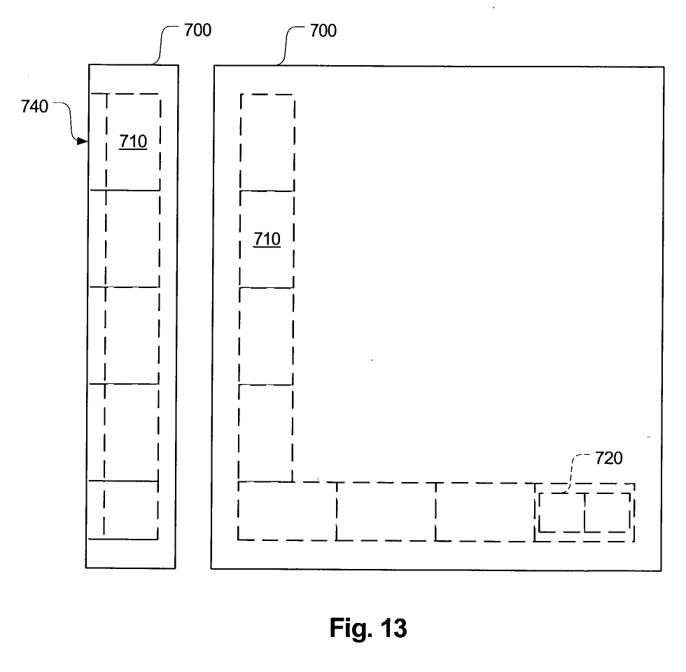

Referring to FIG. 13, in the preferred method of mounting, the modules 710, which may have hydrophones and signal conditioning circuitry, are inserted into recesses 740 in a block 700 of potting material. A filler material (not shown) may be provided to insure that there are no air gaps between the potted modules and the “chassis.” Oil, tar, or elastomer may be used for this purpose. Each of the receivers may also be potted alone. An interface may provide the module with input of power and a clocking signal and the output of a downconverted digital signal ready to be numerically processed into image data. Here, in an example configuration, two receivers 720 are shown potted in each of eight modules 710.

It will be evident to those skilled in the art that the invention is not limited to the details of the foregoing illustrative embodiments, and that the present invention may be embodied in other specific forms without departing from the spirit or essential attributes thereof. The present embodiments are therefore to be considered in all respects as-illustrative and not restrictive, the scope of the invention being indicated by the appended claims rather than by the foregoing description, and all changes which come within the meaning and range of equivalency of the claims are therefore intended to be embraced therein.

1. A sonar system, comprising:
an array of sonar sensors configured to receive an echo and generate a raw data signal;
at least one emitter configured to project a beam of sonic energy effective to generate said echo;
circuitry adapted to collect and reduce said raw data signal to, and output, image data;
a communications system configured to distribute said image data, in real time, to:
at least one terminal on a floating vessel and at least one terminal on land;
at least two terminals, each on respective separate vessel;
at least one terminal configured to render selectable projections of said image data, said image data including three-dimensional data;
at least one terminal configured to render a map with features overlaid thereon responsive to said image data;
at least one terminal configured to render a projection with features indicated as symbols responsive to said image data and classification data; and
at least one terminal that produces an audible or visual alarm responsive to said image data.

2. A system as in claim 1, wherein said communications system is a network

3. A system as in claim 2, wherein said network is a wireless network.

4. A system as in claim 1, wherein said image data includes indicators of three dimensional positions of voxels plus echo intensity.

5. A system as in claim 1, wherein said network is configured to distribute said image data, in real time, to at least one terminal on a floating vessel and at least one terminal on land.

6. A system as in claim 1, wherein said network is configured to distribute said image data, in real time, to two terminals on separate vessels;

7. A system as in claim 1, wherein said network is configured to distribute said image data, in real time, to at least one terminal configured to render selectable projections of said image data, said image data including three-dimensional data.

8. A system as in claim 1, wherein said network is configured to distribute said image data, in real time, to at least one terminal configured to render a map with features overlaid thereon responsive to said image data.

9. A system as in claim 1, wherein said network is configured to distribute said image data, in real time, to at least one terminal configured to render a projection with features indicated as symbols responsive to said image data and classification data.

10. A system as in claim 9, wherein said at least one terminal is configured to render said symbols responsive to a network classifier process running on at least one of a central server and said at least one terminal, said network classifier programmed to recognize sonar data features.

11. A system as in claim 1, wherein said net work is configured to distribute said image data to at least one terminal configured to produce an audible or visual alarm responsive to said image data

12. A sonar system, comprising:
a sonar emitter;
a sparse array of sonar sensors configured to receive an echo from an outgoing signal generated by said emitter and generate a raw data signal;
a sensor located to sense a property of water near said array; and
a processor programmed to derive three-dimensional image data from said raw data signal responsively to each said outgoing signal and said property.

13. A sonar system, comprising:
a sonar emitter;
a sparse array of sonar sensors configured to receive an echo from an outgoing signal generated by said emitter and generate a raw data signal;
said array being attached to a hull of a sea vessel in a pattern conforming generally to a surface of said vessel;
a processor programmed to derive three-dimensional image data from said raw data signal responsively to each said outgoing signal.

14. A sonar system, comprising:
a sonar emitter;
a sonar array of sonar sensors configured to receive an echo from an outgoing signal generated by said emitter and generate a raw data signal;
a controller configured to select a frequency of said echo responsively to an audio signal received from a source other than said outgoing signal.

15. A sonar array, comprising:
sonar sensors configured to receive an echo from an outgoing signal generated by said emitter and generate a raw data signal;
said sonar sensors including modules each having multiple ones of said sonar sensors encased therein, wherein at least one of said sonar sensors encased therein is shorter than another such that when laid adjacent to one other that said each, a regular spacing may be maintained between adjacent ones of said sensors encased therein even for those in separate ones of said modules.

16. A sonar system, comprising:
an array of sonar sensors configured to receive an echo and generate a raw data signal;
at least one emitter configured to project a beam of sonic energy effective to generate said echo;
at least one of a roll, tilt, and yaw sensor;
circuitry adapted to collect and reduce said raw data signal to, and output, image data, responsively to said at least one of a roll tilt and yaw sensor.

17. A sonar system as in claim 16, wherein said circuitry is adapted to reduce said raw data signal to image data including three-dimensional image data.

18. A sonar system as in claim 17, wherein said image data includes coordinate data with respect to a frame of reference fixed with respect to earth.
